(19) United States
(12) Patent Application Publication
(10) Pub. No.: US 2026/0208904 A1
(43) Pub. Date: Jul. 23, 2026

(54) APPARATUS AND METHOD FOR AUTOMATICALLY MOVING OBJECTS WITHIN A MODIFIED ATMOSPHERE ENVIRONMENT

(71) Applicant: I.M.A. INDUSTRIA MACCHINE AUTOMATICHE S.P.A., OZZANO DELL'EMILIA (BO) (IT)

(72) Inventors: Claudio TREBBI, OZZANO DELL'EMILIA (BO) (IT); Alessandro FARNE', OZZANO DELL'EMILIA (BO) (IT); Gianluca ZAULI, OZZANO DELL'EMILIA (BO) (IT); Daniele RICCIARDI, OZZANO DELL'EMILIA (BO) (IT); Filippo MEARINI, OZZANO DELL'EMILIA (BO) (IT); Sergio MANERA, OZZANO DELL'EMILIA (BO) (IT); Annalisa MALFATTO, OZZANO DELL'EMILIA (BO) (IT)

(21) Appl. No.: 19/143,045

(22) PCT Filed: Dec. 12, 2023
(86) PCT No.: PCT/IT2023/095001

§ 371 Date: Jun. 25, 2025

(30) Foreign Application Priority Data
Dec. 28, 2022 (IT) 102022000026922

(51) Int. Cl. B65B 55/02; B25J 21/02; B65B 3/00; B65B 7/28; B65G 54/02

(52) U.S. Cl. CPC B65B 55/027; B25J 21/02; B65B 3/003; B65B 7/2821; B65G 54/02

(57) ABSTRACT

An apparatus and method for automatically moving objects within a modified atmosphere environment includes a main chamber confined from the external environment, one or more base plates placed reciprocally contiguous to each other defining a driving surface; one or more working stations; and one or more transport members, each configured to support the objects and configured to move contactless in a coordinated manner on the driving surface among the one or more working stations by magnetic interaction between the base plates and the transport members.

### FIELD OF THE INVENTION

The present invention concerns an apparatus and a method for automatically moving objects, in particular, but not only, ones that are very delicate, fragile, or of small sizes, such as for example vials, flasks, phials, syringes, needles, Petri dishes, or suchlike, within a controlled atmosphere environment, for example sterile, sterilized, or bacteriologically pure. By way of a non-limiting example, the apparatus and method according to the present invention can find application in the pharmaceutical, cosmetic, healthcare, chemical and/or food fields, or sectors, for example as an integral part of a more complex machine for the automatic packaging of the aforementioned products.

### BACKGROUND OF THE INVENTION

Different methods and apparatuses are known in the pharmaceutical, cosmetic, healthcare, chemical and/or food sectors for automatically moving objects, in particular, but not only, ones that are very delicate, fragile, or of small sizes, such as for example vials, flasks, phials, syringes, needles, Petri dishes, or suchlike, within a controlled atmosphere environment, for example sterile, sterilized, or bacteriologically pure. For example, the same Applicant has designed, embodied and marketed a complex and automated machine that uses a plurality of robots, called “Ima Life Injecta”, which is suitable for automatically packaging, within a series of working compartments with a controlled atmosphere inside them, pharmaceutical products into special containers, with a very high productivity, of the order of 36,000 products/hour.

In the aforementioned sectors, there is an increasing demand for apparatuses and methods that allow to displace different objects from one point to another on the working line, or from one working station to another working station within an environment that is safe and aseptic, ecologically sustainable and silent, without generating pollutants and agents that could contaminate the objects themselves and the final products, and in which human intervention to carry out the various packaging operations is reduced to a minimum, or better still completely eliminated.

In recent years, the same Applicant has designed and developed a number of new and original technical solutions, many of which have been protected by filing patent applications, some of which have been published, for example international patent applications WO 2020/144722, WO 2020/240601, WO 2021/001863, WO 2021/014476 and WO 2022/201207.

Some of the above technical solutions provide to use planar motors, well known in the art, which comprise, briefly, magnetic means, for example permanent magnets, which cooperate with electric energizing means operatively associated with them and configured to selectively generate one or more magnetic fields to influence the magnetic means. In some embodiments, the magnetic means are mounted on a transport member, known to the people of skill in the art as “mover”, while the electric energizing means, for example comprising coils, are incorporated within a base plate having a fixed reference surface, with respect to which the transport member can move, advantageously without contacting it, thanks to the controlled electromagnetic field which is selectively generated between the magnetic means and the electric energizing means. Usually, each transport member can move independently of the others with respect to the fixed reference surface, remaining at a distance from the latter of the order of a few millimeters, for example from 1 to 4 mm, with even high speeds, of the order of a few meters per second, for example 4 m/s, with considerable accelerations, even greater than G or 2 G, and with a positioning accuracy of a few microns. In addition, the planar motors currently available on the market are very versatile and allow to follow the most varied trajectories and diverse paths, not only rectilinear, or curved, and not only horizontal, with respect to the reference surface, by suitably commanding the electric energizing means, for example using even complex software available on the market.

Planar motors are also used to transfer objects of small sizes in other technical sectors, such as for example the working of semiconductor materials (wafers). An example of the application of this technology in this sector is described in document WO 2021/106796 A1. In this known solution, the planar motors move the wafers in a vacuum transfer chamber, from which it is possible to access the different working chambers. Furthermore, the system described in this document also comprises loading chambers through which it is possible to introduce the wafers into the transfer chamber. A wafer transfer device is provided, placed in the transfer chamber to pick-up the wafers from the loading chambers and from the working chambers and deposit them on the planar motors, or vice versa. Each of the loading or working chambers facing the transfer chamber is separated from the latter by a barrier that is selectively openable to allow the passage of the wafers.

However, known apparatuses and methods do not provide to use planar motors to move objects in order to perform one or more of the following operations:
make them automatically enter from an external environment with a normal atmosphere, that is, not controlled or not sanitized, into an internal and closed environment, for example defined by at least one clean chamber with a controlled atmosphere, that is, sterilized and bacteriologically pure, in which one or more delicate workings can be carried out;
make them exit from the aforementioned clean chamber toward the normal atmosphere environment;
displace them inside the aforementioned clean chamber, between one or more working stations.

In fact, in the state of the art, the movements are carried out exclusively in the following ways, even in combination with each other:
manually, through suitable rapid transfer ports, known to the people of skill in the art with the English acronym RTP;
by means of anthropomorphic robotic arms, or SCARA robots, English acronym for Selective Compliance Articulated Robot Arm, which are a type of industrial robot capable of moving an arm on a horizontal plane and a gripping member, for example of the sucker type, or grippers, for gripping the different objects, which can rise and fall vertically;
by means of linear motors, for example of the tubular type.

Even the solution described by WO 2021/106796 A1 does not allow to overcome these limitations, since the planar motors are only movable within the transfer chamber, but they cannot enter the loading or working chambers to take the objects transported thereon into them. To this end, in this solution, the transfer device, which is configured as one of the aforementioned anthropomorphic robotic arms, placed in the transfer chamber, is required to displace the objects from the loading or working chambers onto the planar motors, or vice versa.

The first of the aforementioned ways, however, has at least the disadvantage of not being precise enough, while the others are too expensive, cumbersome and complex to control in order to achieve high-precision movements.

There is therefore the need to provide an apparatus and develop a method for automatically moving objects, especially very delicate ones, in particular, but not only, those that are very delicate, fragile, or of small sizes, such as for example vials, flasks, phials, syringes, needles, Petri dishes, or suchlike, within a controlled atmosphere environment, for example sterile, sterilized, or bacteriologically pure, for example in the pharmaceutical, cosmetic, healthcare, chemical and/or food sectors, which can overcome at least the above shortcomings that exist in the state of the art.

To do this, it is necessary to solve the technical problem of providing an apparatus and developing a method for automatically moving objects within a controlled atmosphere environment, in which all the work steps are carried out without the risk of producing and dispersing in the work environment, even in minimum quantities, particles and/or dusts that may contaminate the objects themselves.

In particular, one purpose of the present invention is to provide an apparatus and develop a method for automatically moving objects within a controlled atmosphere environment, which are safe and guarantee hygiene and cleanliness standards that make them suitable to also be used in machines for the pharmaceutical, cosmetic, healthcare, chemical and/or food sectors which, as required by the regulations in force in most states, require an aseptic and contaminant-free work environment.

Another purpose of the present invention is to provide an apparatus and to develop a method for automatically moving objects within a controlled atmosphere environment which are reliable and highly efficient, and which allow to have a high productivity, for example of the order of several tens of thousands of operations per hour.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, an apparatus according to the present invention, for automatically moving one or more objects within a modified atmosphere environment, comprises:
a main chamber confined from an external environment;
one or more base plates placed reciprocally contiguous to each other defining a driving surface within the main chamber;
one or more working stations placed within the main chamber;
one or more transport members, each configured to support the one or more objects and configured to move contactless in a coordinated manner with respect to the driving surface among the working stations by means of magnetic interaction between the one or more plates and the one or more transport members;
a loading/unloading chamber placed adjacent to the main chamber; and
a separating door configured to be moved between a closed configuration in which it confines the main chamber from the loading/unloading chamber and an opened configuration in which it puts into communication the main chamber with the loading/unloading chamber.

In accordance with one aspect of the present invention, the driving surface, made of the one or more base plates, extends also within the loading/unloading chamber allowing the loading/unloading chamber to be accessed by the one or more transport members when the separating door is in the opened configuration, so that the one or more transport members can be selectively displaced within the loading/unloading chamber by moving on the driving surface.

In accordance with one aspect of the present invention, the apparatus further comprises electric means associated with, or present in, the one or more base plates and selectively energizable in order to generate one or more magnetic fields at least above the corresponding driving surface; moreover, each of the one or more transport members is provided with magnetic means configured to interact with the one or more magnetic fields, so that the selective energization of the electric means allows the displacement of the one or more transport members, together with the possible one or more objects supported thereby, on the driving surface, in order to displace them selectively among the one or more working stations.

In accordance with another aspect of the present invention, the apparatus also comprises a control unit configured to selectively control the energization of the electric means to allow the displacements of the one or more transport members, or to possibly selectively block each one against the driving surface.

In accordance with another aspect of the present invention, the loading/unloading chamber is provided with at least one access aperture configured to allow the objects to enter the loading/unloading chamber from the external environment.

In accordance with another aspect of the present invention, at least one of the access apertures is provided with at least one rapid transfer port, or RTP.

In accordance with another aspect of the present invention, the apparatus further comprises at least one handling device configured to interact with the objects supported on the one or more transport members within the loading/unloading chamber.

In accordance with another aspect of the present invention, the at least one handling device comprises a pair of gloves attached in a sealed manner on a wall delimiting the loading/unloading chamber.

In accordance with another aspect of the present invention, the at least one handling device comprises a pick-and-place device placed within the loading/unloading chamber.

In accordance with another aspect of the present invention, the one or more working stations comprise at least a filling station and/or a capping station respectively configured to fill and cap the objects having a shape of containers.

In accordance with another aspect of the present invention, the filling station comprises at least a filling needle configured to dose a preestablished quantity of product.

In accordance with another aspect of the present invention, the capping station comprises a pusher to insert a stopper into each of the containers.

In accordance with another aspect of the present invention, the separating door is configured to close an aperture provided on a common wall separating the main chamber and the loading/unloading chamber.

In accordance with another aspect of the present invention, a method for automatically moving one or more objects uses an apparatus according to one or more of the aspects disclosed above, wherein the objects comprise at least a container to be filled and capped.

In accordance with another aspect of the present invention, the one or more objects are filled with liquid.

In accordance with another aspect of the present invention, the one or more objects comprise at least one Petri dish.

In accordance with another aspect of the present invention, the method comprises a decontamination step, in which the separating door is kept in a closed configuration and at least the main chamber is decontaminated with a decontaminant substance, which is preferably VHP.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a partial and schematic top view of an apparatus according to the present invention for automatically moving objects within a modified atmosphere environment, in which the apparatus is integrated into a packaging machine;

FIG. 2 is a partial, sectioned lateral view, on an enlarged scale, of a transport member and of a portion of a base plate which are comprised in the apparatus of FIG. 1;

FIG. 3 is a schematic top view of an apparatus according to the present invention in accordance with a second embodiment.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

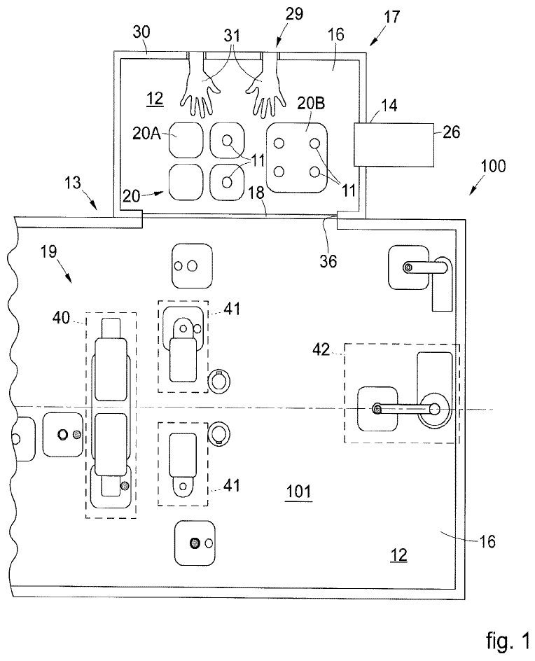

With reference to FIGS. 1 and 3, an apparatus 10 according to the present invention for automatically moving one or more objects 11, for example containers intended to be filled and capped, within a modified atmosphere environment 12, comprises a main chamber 13 which is substantially closed, inside which the environment 12 is created in a known manner. For example, a suitable automated surface decontamination of the objects 11 can be carried out in the environment 12, for example through the nebulization, or vaporization, of hydrogen peroxide (H₂O₂), with VHP methodology, the English acronym for “Vaporized Hydrogen Peroxide”.

Inside the main chamber 13 there are: one or more base plates 15 reciprocally contiguous to each other defining a driving surface 16, advantageously fixed and for example horizontal; one or more working stations 19 comprising, for example, at least a filling station 40 and a capping station 41; and one or more transport members 20, or “movers”, configured to contactless slide, in a coordinated manner, with respect to the driving surface 16, as will be described in detail below.

In the example shown in FIG. 1, the filling station 40 comprises two filling devices, each equipped with a respective filling needle (not shown) for dosing a preestablished quantity of product, in particular a liquid, inside the containers. Similarly, the capping station 41 also comprises two capping devices, each comprising a pusher to insert a stopper into each of the containers. In this way, each station 40, 41 comprises two devices operating simultaneously to increase the productivity of the machine.

In some variants, in the main chamber 13 there is optionally also a crimping station 42, configured to tighten and clamp a safety crimp cap on the objects 11.

The apparatus 10 according to the present invention comprises a loading/unloading chamber 17 adjacent to the main chamber 13.

Between the loading/unloading chamber 17 and the main chamber 13 there is provided a separating door 18, selectively openable and closable, which in fact allows alternatively to put into communication the loading/unloading chamber 17 with the main chamber 13 or to insulate, or confine in a sealed manner, the two chambers. In the first case, the separating door 18 assumes an opened configuration, while in the second case it is brought into a closed configuration.

The apparatus 10 according to the present invention further comprises at least one access aperture 14, which allows to put the environment 12 in communication with the outside.

A rapid transfer port, or RTP, with which a container 26 can be associated, can be associated with the access aperture 14, through which the objects 11 can be introduced into, or extracted from, the environment 12.

In the examples given here (FIGS. 1 and 3), the access aperture 14 is made on a wall of the apparatus 10 placed at the loading/unloading chamber 17.

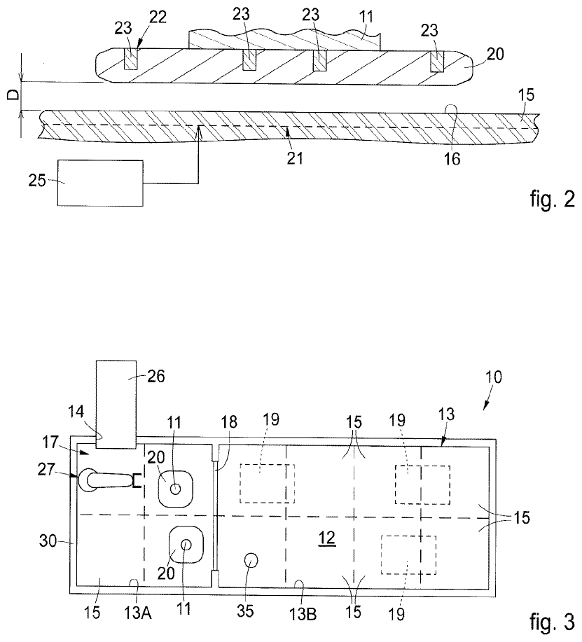

Each base plate 15 (FIG. 2) can be of any known type whatsoever and have the upper surface able to form the driving surface 16 of standard sizes, for example of approximately 250 mm×250 mm.

In an exemplary and non-limiting embodiment, there are N base plates 15 inside the main chamber 13, contiguous to each other and placed, for example, so as to substantially form a square or a rectangle, with the respective upper surfaces coplanar with each other forming the driving surface 16, where N is an integer that depends on the sizes of the main chamber 13 and can be, for example, equal to four.

In the apparatus 10 according to the present invention, there are one or more base plates 15 also in the loading/unloading chamber 17, contiguous to each other with the respective upper surfaces coplanar with each other forming the driving surface 16, wherein the number of plates is a function of the sizes of the loading/unloading chamber 17.

In the apparatus 10 according to the present invention, a single driving surface 16 is therefore provided, which extends both into the main chamber 13 and also into the loading/unloading chamber 17.

The transport members 20 can have different sizes from each other and comprise, for example, small transport members 20a, for example 120×120×10 mm in size, and large transport members 20B, for example 240×240×10 mm in size, readily available on the market.

The objects 11 can comprise, for example: so-called size pieces, of different measurements and sizes, which need replacing inside the main chamber 13 without compromising their sterility; combs, arms, terminals, and working tools, such as for example pincers, scissors, markers; biological indicators, such as for example Petri dishes; elements for the calibration of the instrumentation in the main chamber 13, such as for example a small weight of a known entity for the calibration of scales; or other instruments, or tools, useful for carrying out the different workings to package products of the pharmaceutical, cosmetic, healthcare, chemical and/or food sectors, but not only.

The objects 11 can also be containers of any type whatsoever, in particular of small sizes, such as vials, flasks, phials, or suchlike, commonly used in the sectors as above to be filled with the most diverse products, which can be fluids, solids, in powder form, or gels.

The apparatus 10 further comprises electric means 21 (FIG. 2), for example consisting of, or comprising, coils of a known type and not shown in the drawings, which are associated with, or present in, one or more base plates 15 and selectively energizable in order to generate one or more magnetic fields at least above the driving surface 16. Moreover, each of the transport members 20 is provided with magnetic means 22, for example consisting of, or comprising, magnets 23, for example permanent, of a known type, configured to interact with the aforementioned one or more magnetic fields so that the selective energization of the electric means 21 allows the displacement, understood as linear displacement and/or rotation, even micrometric, of one or more of the transport members 20 with respect to the driving surface 16, without contacting it, in order to selectively displace them with respect to, or into, the working stations 19. During such displacement, the transport members 20 are kept at a distance D from the driving surface 16, varying between a few tenths of a millimeters and a few millimeters.

In other words, the electric means 21 and the magnetic means 22 constitute actual planar motors. The inventive idea is, in fact, to use the latter in the apparatus 10 according to the present invention in order to create the movement of the objects 11 within the environment 12, in particular to displace the objects from the loading/unloading chamber 17 to the main chamber 13, and vice versa.

Furthermore, the apparatus 10 comprises a control unit 25, for example of the electronic and programmable type, configured to selectively energize at least the electric means 21. The control unit 25 is also configured to control the movement of the separating door 18 by taking it into either the closed or the opened configuration.

The apparatus 10 comprises a handling device 29 which is placed in the loading/unloading chamber 17 to allow the handling of the objects 11 located in that chamber.

In a first embodiment, shown in FIG. 1, the handling device 29 can comprise a pair of gloves 31, of a known type and preferably sterile, attached in a sealed manner at a wall 30 of the loading/unloading chamber 17 to allow an operator to interact with the objects 11 placed on the transport members 20.

In accordance with another embodiment, shown in FIG. 3, the handling device 29 comprises a pick-and-place device 27, of a type known in the art. The pick-and-place device 27 can be configured, for example, as an articulated robot with several degrees of freedom, for example six degrees of freedom, and equipped with a gripping member, in particular a gripper, placed at the end of the distal articulated arm. The person of skill in the art will be able to easily provide other embodiments of pick-and-place devices 27 suitable for the purpose, also according to the space available in the loading/unloading chamber 17, such as for example a SCARA robot, a delta robot, or pick-up arms equipped with suckers connected to a pneumatic system, or others.

Moreover, advantageously, one or more Petri dishes 35, of a known type, for example acting as bacterial load detectors, can be placed in one or more points within the chamber 13 (FIG. 1) to verify that the desired hygiene and cleaning conditions are maintained in the environment 12. For example, the Applicant's international patent application WO2020/144722 describes an example of managing the insertion/extraction of Petri dishes in a traditional machine, which does not use planar motors.

In accordance with a first variant, not shown in the drawings but easily understood by a person of skill in the art, one or more base plates 15, with the associated electric means 21, could partly extend, or be placed completely, also outside the chamber 13, that is, at least partly in a normal atmosphere. In the event that, outside the main chamber 13, there are one or more autonomous base plates, but similar or equal to the one or more base plates 15 placed inside the chamber 13, all their respective surfaces contribute to forming the driving surface 16 and are coplanar with it.

In this case, one or more transport members 20 could be used to take one or more objects 11, including one or more Petri dishes 35, from the outside to the inside of the main chamber 13, or from the inside of the latter toward the outside, simply by suitably energizing the electric means 31 associated with the internal and external base plates 15.

The apparatus 10 according to the present invention can be integrated into a more complex machine of a known type, for the automated packaging of products in the above-mentioned sectors, for example in a vial filling machine.

The operation of the apparatus 10, which corresponds to the method for automatically moving the one or more objects 11 within the controlled atmosphere environment 12, essentially comprises the following two steps, for example coordinated and commanded by the control unit 25:
1) a preparation step that provides to create the substantially closed main chamber 13, inside which to then create, in any known manner, the modified atmosphere environment 12 by placing inside the main chamber 13 the base plates 15, the one or more working stations 19, and the transport members 20, each configured to support the one or more objects 11 and contactless slide, in a coordinated manner, with respect to the driving surface 16; wherein the electric means 21 are associated with, or present in, the base plates 15 and are selectively energizable to generate one or more magnetic fields, and wherein each transport member 20 is provided with the magnetic means 22 configured to interact with the one or more magnetic fields;
2) a movement step in which the electric means 21 are selectively energized to generate the one or more magnetic fields, to allow the selective displacement of the one or more transport members 20, together with the possible one or more objects 11 supported by them, with respect to the driving surface 16, in order to selectively displace them among the working stations 19.

It will be evident to the people of skill in the art that the new and original solution of using planar motors, consisting of the electric means 21 and the magnetic means 22, to carry out the automatic movement of objects within the environment 12 brings considerable advantages in terms of reliability, productivity and cleanliness, because they do not produce any polluting agent.

It should be noted that, thanks to the presence of at least one RTP, objects 11 can enter into, or exit from, the main chamber 13. By means of the gloves 31 or the pick-and-place 27 of the handling device 29, the objects 11 can be placed on the various transport members 20 involved, placing them according to their function and/or size, so that there may be, for example, objects 11 of small sizes placed on the smaller transport members 20A, while the bulkier objects 11, such as the frames that carry the known trays provided with special seatings, called “Nests”, are placed on the larger transport members 20B.

The transport members 20, whether they are smaller 20A or larger 20B, are then set in motion to direct them quickly and with great precision toward the different working units positioned in the working stations 19 inside the main chamber 13, in which they will be subjected to the various workings.

When the transport members 20 have to be loaded with the objects 11, the former are located in the loading/unloading chamber 17 and the latter come from outside the apparatus 10, through the access aperture 14 to which the container 26 has been connected.

After that, the operator, using the gloves 31 or commanding the pick-and-place 27, will pick-up the objects 11 from the container 26, possibly after they have already been treated in an autoclave, to deposit them on the transport members 20 that have reached the loading/unloading chamber 17, without ever touching the objects 11 directly.

For example, when the apparatus 10 is provided with only four standard-sized base plates 15, when fully loaded it can have up to sixteen small transport members 20A or up to four large transport members 20B, or a combination thereof. Alternatively, the transport members 20 can enter the loading/unloading chamber 17 one after the other, like a snake, and form, for example, a loop, or another path, waiting to be loaded, and return into the main chamber 13 immediately after the objects 11 have been loaded.

It is clear that the method provides that the control unit 25 takes the separating door 18 into the opened configuration whenever the transport members 20 have to be moved from the main chamber 13 into the loading/unloading chamber 17, or vice versa.

Another function that can be performed with the apparatus 10 can be the entry of one or more Petri dishes 35, or cell culture capsules, into the chamber 13.

It can also be assumed that there will be a column with a storage function to stack all the Petri dishes 35 that are still unused, which are then transferred into the apparatus 10 and then possibly into the machine 100. By means of the access aperture 14 it is possible to introduce and populate the column with the Petri dishes 35, then load these onto the suitable transport members 20, an operation that can be done manually with the gloves 31, for example. First of all, the corresponding lids are removed from the Petri dishes 35 and deposited on a suitable shelf; then one or more open Petri dishes 35 are deposited on one or more transport members 20; and then the one or more Petri dishes 35 are transferred into a monitoring position at the points of the apparatus 10 which are considered critical, which are generally identified at one of the access apertures 14, for the entry and exit of the objects 11, and in the working stations 19 for the dosing and capping.

The necessary sanitization cycles of the transport members 20 and objects 11 are carried out advantageously with the separating door 18 placed in the closed configuration, for example by delivering a decontaminating agent, such as VHP for example, into the main chamber 13, after the transport members 20 have been magnetic lifted with respect to the driving surface 16 in order to allow the VHP to also reach the latter and underneath the transport members 20. In this case, it is provided to close the separating door 18 before decontaminating the main chamber 13 and all the objects contained therein.

In addition, an automatic system with an arm can be provided to load the Petri dishes 35, in which case the dimensions of the apparatus 10 have to be adequately sized, for example by increasing the internal space of the main chamber 13, to accommodate the arm and allow it to move.

Moreover, a transport member 20 can remain parked in the apparatus 10, functioning as a “sweeper”. In fact, the latter could be provided with a kind of shovel that can push, like a broom, the objects 11, any fallen waste and/or pieces of broken material toward the apparatus 10, so that they can be taken out of the main chamber 13. Also, two transport members 20 of this type could work together and help each other to load the material onto one of them so that it does not drag on the driving surface 16 along the pushing path.

It is clear from the above description that the transport members 20 are able to move automatically within the main chamber 13, that is, between the working stations 19, or between the loading/unloading chamber 17 and the main chamber 13.

It is therefore advantageous and inventive that a same transport member 20 on which one or more objects 11 are placed accommodates them in the loading/unloading chamber 17 and then moves them toward one or more working stations 19, and that the same objects 11 remain on the same transport member 20 during the various workings. This prevents any transfers of objects between different movement members, therefore the apparatus 10 is less complex and easier to control.

It is also provided that the objects 11 are positionable on each transport member 20 in an orderly and organized manner, and that they can be exchanged between one transport member 20 and another quickly and easily.

It is clear that modifications and/or additions of parts or steps may be made to the apparatus 10 and to the method for automatically moving one or more objects 11 within a controlled atmosphere environment 12 as described heretofore, without departing from the scope of the present invention, as defined by the claims.

It is also clear that, although the present invention has been described with reference to some specific examples, a person of skill in the art will be able to achieve other equivalent forms of apparatuses and methods for automatically moving objects within a controlled atmosphere environment, having the characteristics as set forth in the claims and hence all coming within the scope of protection defined thereby.

In the following claims, the sole purpose of the references in brackets is to facilitate their reading and they must not be considered as restrictive factors with regard to the field of protection defined by the claims.

1. Apparatus for automatically moving one or more objects within a modified atmosphere environment, said apparatus comprising:
a main chamber confined from an external environment,
one or more base plates placed reciprocally contiguous to each other defining a driving surface within the main chamber,
one or more working stations arranged within said main chamber,
one or more transport members, each configured to support said one or more objects and configured to move contactless in a coordinated manner on said driving surface among said one or more working stations by means of magnetic interaction between said one or more base plates and said one or more transport members,
a loading/unloading chamber arranged adjacent to said main chamber, and
a separating door configured to be moved between a closed configuration in which the separating door confines the main chamber from the loading/unloading chamber and an opened configuration in which the separating door puts into communication the main chamber with the loading/unloading chamber, wherein said driving surface, made of said one or more base plates, extends also within the loading/unloading chamber allowing said loading/unloading chamber to be accessed by said one or more transport members when the separating door is in the opened configuration, so that said one or more transport members can be selectively displaced within the loading/unloading chamber by moving on said driving surface.

2. Apparatus as in claim 1, further comprising electric means associated with, or present in, said one or more base plates and selectively energizable in order to generate one or more magnetic fields, and magnetic means provided on said one or more transport members and configured to interact with said one or more magnetic fields, so that the selective energization of said electric means allows the displacement of said one or more transport members on said driving surface.

3. Apparatus as in claim 1, wherein said loading/unloading chamber is provided with at least one access aperture configured to allow the objects to enter the loading/unloading chamber from the external environment.

4. Apparatus as in claim 3, wherein a rapid transfer port is connected to at least one of said access apertures.

5. Apparatus as in claim 1, further comprising at least one handling device configured to interact with said objects supported on said one or more transport members within said loading/unloading chamber.

6. Apparatus as in claim 5, wherein said at least one handling device comprises a pair of gloves attached in a sealed manner on a wall of said loading/unloading chamber.

7. Apparatus as in claim 5, wherein said at least one handling device comprises a pick-and-place device placed within said loading/unloading chamber.

8. Apparatus as in claim 1, wherein said one or more working stations comprise at least a filling station and/or a capping station respectively configured to fill and cap said objects having a shape of containers.

9. Apparatus as in claim 8, wherein said filling station comprises at least a filling needle configured to dose a preestablished quantity of product.

10. Apparatus as in claim 8, wherein said capping station comprises a pusher to insert a stopper into each of said containers.

11. Apparatus as in claim 1, wherein said separating door is configured to close an aperture provided on a common wall separating the main chamber and the loading/unloading chamber.

12. Method for automatically moving one or more objects by using an apparatus as in claim 1, wherein said one or more objects comprise at least a container to be filled and capped.

13. Method as in claim 12, wherein said one or more objects are filled with liquid.

14. Method for automatically moving one or more objects by using an apparatus as in claim 1, wherein said one or more objects comprise at least one Petri dish.

15. Method as in claim 12, further comprising a decontamination step, during which the separating door is kept in a closed configuration and at least said main chamber is decontaminated with a decontaminant substance.
